(19) United States
(12) Patent Application Publication
(10) Pub. No.: US 2002/0048176 A1
(43) Pub. Date: Apr. 25, 2002

(54) Cusp illuminator and flat panel illuminator made thereby

(76) Inventors: Mitchell C. Ruda, Tucson, AZ (US); Robert A. Lieberman, Torrance, CA (US)

Correspondence Address: Lawrence S. Cohen, Intelligent Optical Systems, Inc., 2520 W. 237th Street, Torrance, CA, 90505-5217, US

(21) Appl. No.: 09/795,502

(22) Filed: Feb. 27, 2001

Related U.S. Application Data
(63) Continuation-in-part of application No. 09/685,387, filed on Oct. 10, 2000.

(51) Int. Cl. F21V 7/04; F21V 7/00

(52) U.S. Cl. 362/551; 362/346; 362/297; 362/247; 362/241

(57) ABSTRACT

A light reflector apparatus using an illumination optical fiber to produce a uniform illumination pattern is disclosed. By controlling the propagation of light in the core and cladding regions of an optical fiber, uniform light emission along the length of the fiber can be achieved. Using the illumination fiber as a light source in an open cusp reflector assembly provides for uniform dispersion of the emitted light over the exit faces of the reflector.

### REFERENCE TO RELATED APPLICATIONS

This application is a Continuation-in Part of application Ser. No. 09/685,387 filed Oct. 10, 2000 the entire content of which is incorporated by reference herein.

### FIELD OF THE INVENTION

The present invention relates generally to the propagation and emission of light in optical fibers and more particularly to a method for uniformly distributing a reflected light pattern in an optical fiber assembly.

### BACKGROUND OF THE INVENTION

Optical fibers are being used, with increasing regularity, to transmit light in sensor applications. Optical fibers can also be designed with light emission properties, suitable for illumination, as illustrated in the above noted copending application that describes techniques for controlling light emission in an optical fiber to produce a uniform illumination pattern of radially emitted light along the length of the fiber.

### BRIEF SUMMARY OF THE INVENTION

The present invention comprises apparatus including a reflector assembly and an illumination optical fiber. The illumination fiber is used as a light source and is based on the realization that an optical fiber's light emission characteristics can be controlled by changing, for example, the fiber core/cladding refractive index ratio and/or the absorption and scattering coefficients of the core and cladding, to allow uniform radial emission of light along the fiber length for illumination. In one embodiment of the invention, the fiber is positioned in an open cusp reflector to permit uniform dispersion of the emitted light over the exit faces of the reflector. By arranging a plurality of such cusp reflectors, an inexpensive backplane illuminator is achieved.

### BRIEF DESCRIPTION OF THE SEVERAL VIEWS OF THE DRAWING

FIG. 1 is an illustrative view of an illumination optical fiber;

FIG. 2 shows a power distribution curve of light emission along an illumination fiber; and

FIG. 3 is a view of a reflective cusp illuminator array

FIG. 4 is a view of a reflective cusp illuminator array forming a backplane illuminator.

### DETAILED DESCRIPTION OF THE INVENTION

In accordance with the principles of the invention, a radial emission illumination fiber is used as a light source in a cusp reflector assembly, to produce a uniform reflected light dispersion pattern. Applications where even illumination is required include, for example, backplane illuminators. The cusp reflector is well known in the art for concentrating illumination in a specific area as shown, for example, in U.S. Pat. No. 4,383,289 where a task light fixture concentrates light at the center of a work area.

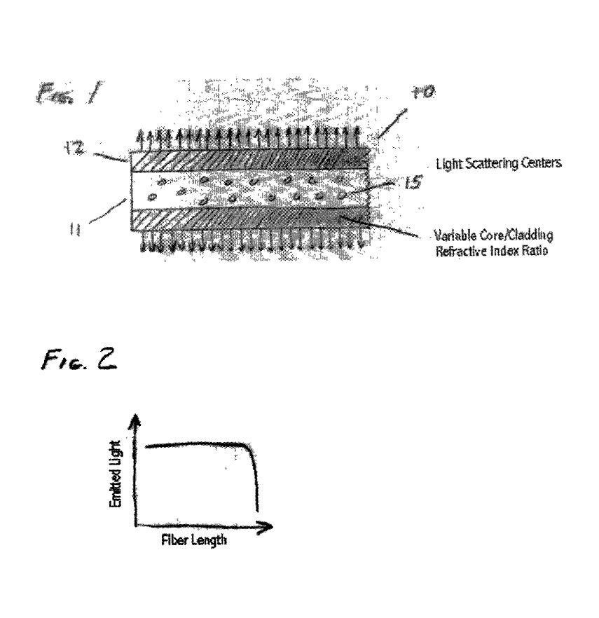

With reference to FIG. 1, an illumination optical fiber 10 having a core 11 and a surrounding cladding 12 emits light when the fiber is fabricated with a variable core/cladding refractive index ratio along the length of the fiber, when the fiber diameter changes along the length of the fiber, and/or when the core is interspersed with refractive and/or reflective light scattering centers 15 whose concentration varies along the length of the fiber, so that light is radially emitted in a uniform manner as shown in the power distribution curve of FIG. 2.

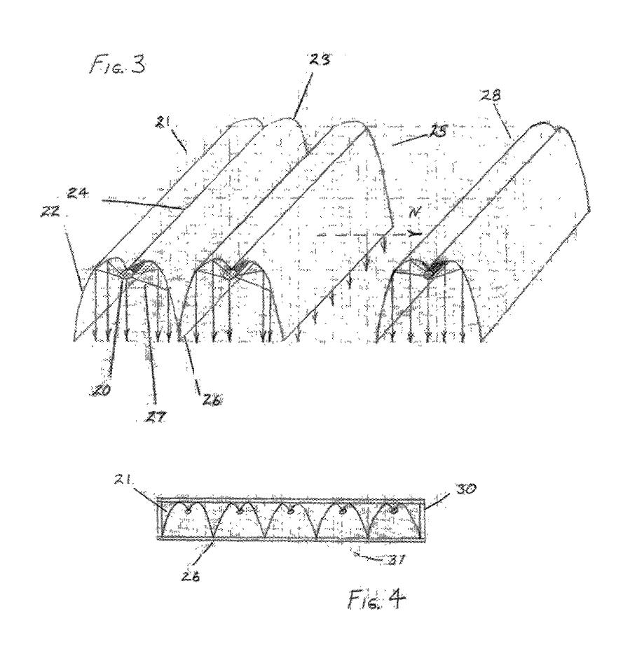

With reference to FIG. 3, a uniform radial emission illumination fiber 20 is shown as a source of light in a light reflector assembly 21. The fiber is located adjacent to a first reflecting compound curve involute surface 22 and a second reflecting compound curve involute surface 23 having edge boundaries joined to form a cusp 24.

The involute surfaces 22 and 23 are joined to locate the cusp 24 between them in an arcuate path in a plane intersecting the involute surfaces. Light 27 emitted along the length of the fiber is directed against the involute surfaces 22 and 23 and is reflected in accordance with the length of the individual involute surfaces and in accordance with the curvature of each of the involute surfaces to spread the reflected light in a desired uniform illumination pattern.

A similar second light reflecting assembly 25 may be joined to the first assembly 21 along a common edge boundary 26 to provide an extended light dispersion area. Additional light reflecting assemblies 28 may be added as indicated at n in FIG. 3 to form, for example, a backplane illuminator for liquid crystal displays. The additional light reflecting assemblies 28 are arranged adjacently so that their edge boundaries 26 are closely adjacent, forming an illuminator for a flat panel.

FIG. 4 shows an exemplary arrangement in which a plurality of light reflector assemblies 21 are held in a frame 30 and a glass or plastic dispersion plate 31 is placed over the opening of the frame to provide a more even illumination. The common edge boundaries 26 of the adjacent light reflector assemblies 21 are adjacent in contact or close together.

Although the various features of novelty that characterize the invention have been described in terms of certain preferred embodiments, other embodiments will become apparent to those of ordinary skill in the art, in view of the disclosure herein. Accordingly, the present invention is not intended to be limited by the recitation of the preferred embodiments, but is instead intended to be defined solely by reference to the appended claims.

What is claimed is:

1. A light reflecting apparatus having at least one uniform radial emission light source and a cusp reflector comprising:
first and second compound curve light reflecting involute surfaces having edge boundaries thereon joined to form a cusp;
each of said compound curve light reflecting involute surfaces being joined to locate the cusp between them;
a uniform radial emission illumination optical fiber located adjacent to and aligned with said cusp operable to direct light against said involute surfaces for producing reflected light dispersion.

2. The apparatus of claim 1 wherein each of said involute surfaces has an outboard edge thereon laterally displaced from the cusp therebetween.

3. The apparatus of claim 1 wherein said optical fiber is located in the same plane as said cusp to direct light from the cusp to the outboard edge of each of said involute surfaces for reflection therefrom.

4. The apparatus of claim 1 wherein said involute surfaces are symmetrical about a plane including said cusp.

5. The apparatus of claim 1 wherein said reflected light dispersion is established by the vertical extent of the individual involute surfaces and the curvature of each of the individual involute surfaces to spread the reflected light in a desired uniform illumination pattern.

6. An apparatus having a plurality of light reflecting assemblies, each assembly comprising:
first and second compound curve light reflecting involute surfaces having edge boundaries thereon joined to form a cusp;
each of said compound curve light reflecting involute surfaces being joined to locate the cusp between them;
a uniform radial emission illumination optical fiber located adjacent said cusp operable to direct light against said involute surfaces for producing reflected light dispersion;
each of said light reflecting assemblies in adjacent relationship to provide an extended light dispersion area.

7. The apparatus of claim 6 in which said light reflected dispersion is established by the vertical extent of the individual involute surfaces and the curvature of each of the individual involute surfaces to spread the reflected light in a desired uniform illumination pattern.

8. The apparatus of claim 6 in which said adjacent relationship includes adjacent light reflecting assemblies being in contact at a common edge boundary.

9. A flat panel illumination apparatus comprising:
a plurality of light reflecting assemblies in adjacent relationship;
a frame in which said plurality of light reflecting assemblies are mounted; the light reflecting assemblies comprising:
first and second compound curve light reflecting involute surfaces having edge boundaries thereon joined to form a cusp;
each of said compound curve light reflecting involute surfaces being joined to locate the cusp between them;
a uniform radial emission illumination optical fiber located adjacent to and aligned with said cusp operable to direct light against said involute surfaces for producing reflected light dispersion.

10. The apparatus of claim 9 further comprising a transparent or translucent panel located over the openings of the plurality of light reflecting assemblies.
